(19) United States
(12) Patent Application Publication
(10) Pub. No.: US 2022/0084308 A1
(43) Pub. Date: Mar. 17, 2022

(54) METHOD AND DEVICE FOR IMAGE SEARCH, AND STORAGE MEDIUM

(71) Applicant: SHENZHEN SENSETIME TECHNOLOGY CO., LTD., Shenzhen (CN)

(72) Inventors: Zhanghui KUANG, Shenzhen (CN); Wei ZHANG, Shenzhen (CN); Hongzhen SONG, Shenzhen (CN); Yimin CHEN, Shenzhen (CN)

(21) Appl. No.: 17/536,708

(22) Filed: Nov. 29, 2021

Related U.S. Application Data
(63) Continuation of application No. PCT/CN2020/086455, filed on Apr. 23, 2020.

(30) Foreign Application Priority Data
Aug. 29, 2019 (CN) 201910806958.2

(51) Int. Cl. G06V 10/74; G06V 10/40; G06V 10/82; G06V 10/75; G06V 10/86; G06F 16/532; G06N 3/04

(52) U.S. Cl. CPC G06V 10/761; G06V 10/40; G06V 10/82; G06N 3/04; G06V 10/86; G06F 16/532; G06V 10/757

(57) ABSTRACT

A first feature map corresponding to a first image and a second feature map corresponding to a second image are acquired by performing feature extraction respectively on the first image and the second image according to each scale of preset multiple scales. Similarity between the first feature map and the second feature map located at any two spatial locations is computed corresponding to a target scale combination of the preset multiple scales. An undirected graph is established according to similarities corresponding to respective target scale combinations. The undirected graph is input to a graph neural network that is pre-established. It is determined, according to an output result output by the graph neural network, whether the second image matches the first image.

### CROSS-REFERENCE TO RELATED APPLICATION

This application is a continuation of International Application No. PCT/CN2020/086455, filed on Apr. 23, 2020, which per se is based on, and claims benefit of priority to, Chinese Application No. 201910806958.2, filed on Aug. 29, 2019. The disclosures of International Application No. PCT/CN2020/086455 and Chinese Application No. 201910806958.2 are hereby incorporated by reference in their entireties.

### TECHNICAL FIELD

The subject disclosure relates to the field of image processing, and more particularly, to a method and device for image search, and a storage medium.

### BACKGROUND

When images in an image library are searched for a match to an existing image, a global similarity between two images may be computed using a neural network, thereby finding, in the image library, an image that matches the existing image.

However, when a global similarity between two images is computed, background interference information in the images may have a major impact on the outcome of the computation. For example, difference in angles of the images, difference in content information of the images, blockage, etc., may lead to an inaccurate final search result.

### SUMMARY

Embodiments herein provide a method and device for image search, and a storage medium.

According to an aspect herein, a method for image search includes: acquiring a first feature map corresponding to a first image and a second feature map corresponding to a second image by performing feature extraction respectively on the first image and the second image according to each scale of preset multiple scales, wherein the second image is any image in an image library; computing, corresponding to a target scale combination of the preset multiple scales, similarity between the first feature map and the second feature map located at any two spatial locations, wherein the target scale combination includes a first scale corresponding to the first feature map and a second scale corresponding to the second feature map, the first scale and the second scale each being any scale of the preset multiple scales; establishing an undirected graph according to similarities corresponding to respective target scale combinations; inputting the undirected graph to a graph neural network that is pre-established, and determining, according to an output result output by the graph neural network, whether the second image matches the first image. In the embodiment, first feature maps corresponding to a first image and second feature maps corresponding to a second image in an image library may be acquired by performing feature extraction respectively on the first image and the second image according to preset multiple scales. A similarity between a first feature map and a second feature map located at any two spatial locations may be computed, acquiring a similarity corresponding to a target scale combination. An undirected graph may be established according to similarities corresponding to respective target scale combinations. The undirected graph may be input to a graph neural network that is pre-established. It may be determined whether the second image is a target image matching the first image. The process is no longer limited to global similarity analysis based on overall scales of two images. Instead, similarity analysis is performed combining preset multiple scales. It is determined whether two images match each other according to a local similarity between the first feature map of the first image corresponding to the first scale and the second feature map of the second image corresponding to the second scale located at any two spatial locations, improving a precision and robustness of the matching.

According to an aspect herein, a device for image search includes a feature extracting module, a computing module, an undirected graph establishing module, and a matching result determining module. The feature extracting module is adapted to acquiring a first feature map corresponding to a first image and a second feature map corresponding to a second image by performing feature extraction respectively on the first image and the second image according to each scale of preset multiple scales. The second image is any image in an image library. The computing module is adapted to computing, corresponding to a target scale combination of the preset multiple scales, similarity between the first feature map and the second feature map located at any two spatial locations. The target scale combination includes a first scale corresponding to the first feature map and a second scale corresponding to the second feature map. The first scale and the second scale each are any scale of the preset multiple scales. The undirected graph establishing module is adapted to establishing an undirected graph according to similarities corresponding to respective target scale combinations. The matching result determining module is adapted to inputting the undirected graph to a graph neural network that is pre-established, and determining, according to an output result output by the graph neural network, whether the second image matches the first image. The embodiment is no longer limited to global similarity analysis based on overall scales of two images. Instead, similarity analysis is performed combining preset multiple scales. It is determined whether two images match each other according to a local similarity between the first feature map of the first image corresponding to the first scale and the second feature map of the second image corresponding to the second scale located at any two spatial locations, improving a precision and robustness of the matching.

According to an aspect herein, a non-transitory computer-readable storage medium has stored thereon computer-executable instructions for implementing any method for image search of the first aspect herein.

According to an aspect herein, a device for image search includes a processor and memory. The memory is adapted to storing instructions executable by the processor. The processor is adapted to implementing, by calling the executable instructions stored in the memory, any method for image search of the first aspect herein.

Note that the general description above and the elaboration below are exemplary and explanatory only, and do not limit the subject disclosure.

### BRIEF DESCRIPTION OF THE ACCOMPANYING DRAWINGS

Drawings here are incorporated in and constitute part of the subject disclosure, illustrate embodiments according to the subject disclosure, and together with the subject disclosure, serve to explain the principle of the subject disclosure.

FIG. 1 is a flowchart of a method for image search according to an exemplary embodiment herein.

Each of FIG. 2A to FIG. 2C is a diagram of a first image corresponding to a scale according to an exemplary embodiment herein.

Each of FIG. 3A to FIG. 3C is a diagram of a second image corresponding to a scale according to an exemplary embodiment herein.

FIG. 4 is a diagram of a structure of an image pyramid according to an exemplary embodiment herein.

Each of FIG. 5A to FIG. 5B is a diagram of dividing an image into spatial windows according to an exemplary embodiment herein.

FIG. 6 is a diagram of a structure of a similarity pyramid according to an exemplary embodiment herein.

FIG. 7 is a diagram of a structure of a target undirected graph according to an exemplary embodiment herein.

FIG. 8 is a diagram of dividing an image according to a scale, according to an exemplary embodiment herein.

FIG. 9 is a flowchart of a method for image search according to an exemplary embodiment herein.

Each of FIG. 10A to FIG. 10B is a diagram of pooling processing according to an exemplary embodiment herein.

FIG. 11 is a flowchart of a method for image search according to an exemplary embodiment herein.

FIG. 12 is a diagram of a structure of an image search network according to an exemplary embodiment herein.

FIG. 13 is a block diagram of a device for image search according to an exemplary embodiment herein.

FIG. 14 is a diagram of a structure of a device for image search according to an exemplary embodiment herein.

### DETAILED DESCRIPTION

Exemplary embodiments (examples of which are illustrated in the accompanying drawings) are elaborated below. The following description refers to the accompanying drawings, in which identical or similar elements in two drawings are denoted by identical reference numerals unless indicated otherwise. Implementations set forth in the following exemplary embodiments do not represent all implementations in accordance with the subject disclosure. Rather, they are mere examples of the apparatus (i.e., device) and method in accordance with certain aspects of the subject disclosure as recited in the accompanying claims.

A term used in an embodiment herein is merely for describing the embodiment instead of limiting the subject disclosure. A singular form “a” and “the” used in an embodiment herein and the appended claims may also be intended to include a plural form, unless clearly indicated otherwise by context. Further note that a term “and/or” used herein may refer to and contain any combination or all possible combinations of one or more associated listed items.

Note that although a term such as first, second, third may be adopted in an embodiment herein to describe various kinds of information, such information should not be limited to such a term. Such a term is merely for distinguishing information of the same type. For example, without departing from the scope of the embodiments herein, the first information may also be referred to as the second information. Similarly, the second information may also be referred to as the first information. Depending on the context, a term “if” as used herein may be interpreted as “when” or “while” or “in response to determining that”.

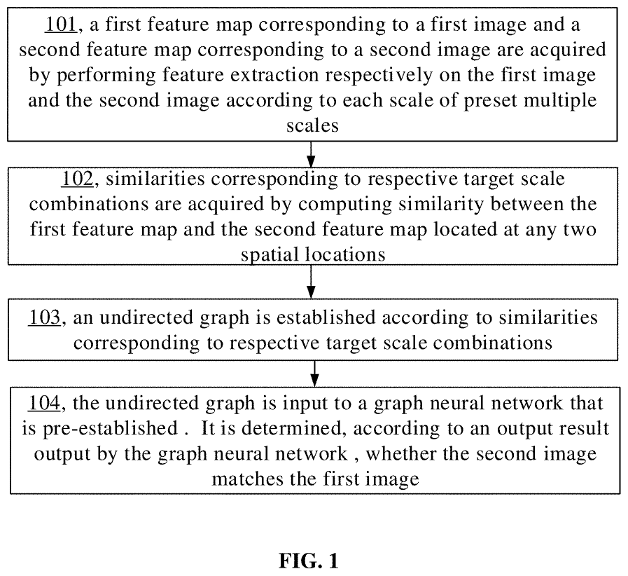

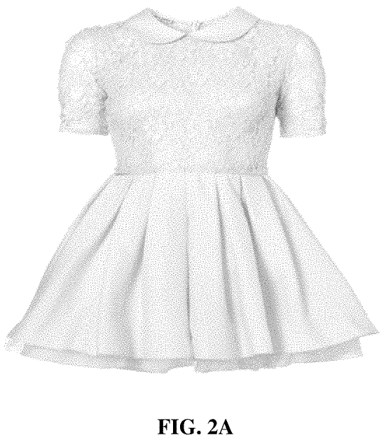

Embodiments herein provide a method for image search. The method may be used on machine equipment or device for performing image search, or may be implemented by a processor by running a computer-executable code. FIG. 1 is a method for image search according to an exemplary embodiment. As shown in FIG. 1, the method includes steps as follows.

In S101, a first feature map corresponding to a first image and a second feature map corresponding to a second image are acquired by performing feature extraction respectively on the first image and the second image according to each scale of preset multiple scales.

The first image may be a target image to which a match is to be searched for. The second image is any image in an image library. For example, the image library may be an image library associated with content of the first image. The first image and the second image may or may not be identical in size, which is not limited hereto.

For example, the first image may be an image related to clothing. Then, the image library may be the well-known image libraries DeepFashion and Street2Shop, or another image library associated with clothing. The second image may be any image in the image library.

Before feature extraction is performed, first, images on each of the multiple scales that correspond respectively to the first image and the second image may be acquired.

For example, an image on a scale 1 (such as 1×1) corresponding to the first image may be acquired, as shown in FIG. 2A. Images on a scale 2 (such as 2×2) corresponding to the first image may be acquired, as shown in FIG. 2B. Images on a scale 3 (such as 3×3) corresponding to the first image may be acquired, as shown in FIG. 2C. Likewise, an image on the scale 1 corresponding to the second image may be acquired, as shown in FIG. 3A. Images on the scale 2 corresponding to the second image may be acquired, as shown in FIG. 3B. Images on the scale 3 corresponding to the second image may be acquired, as shown in FIG. 3C.

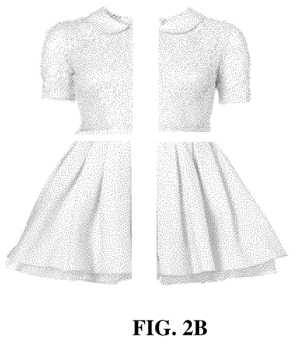

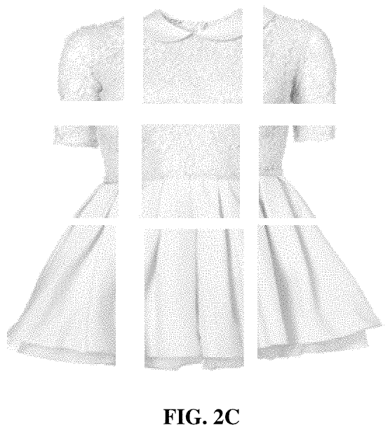

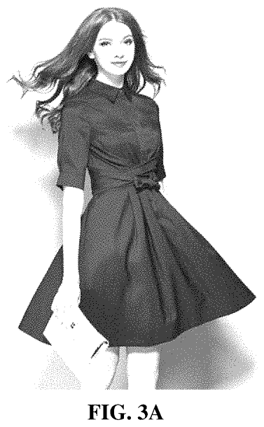

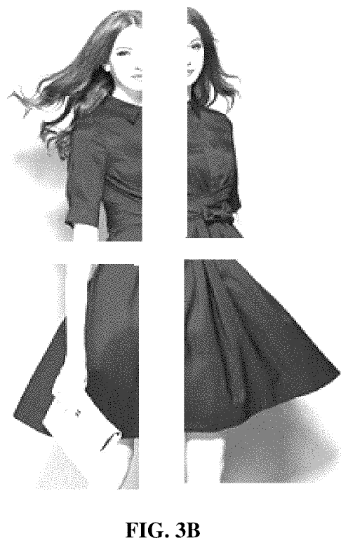

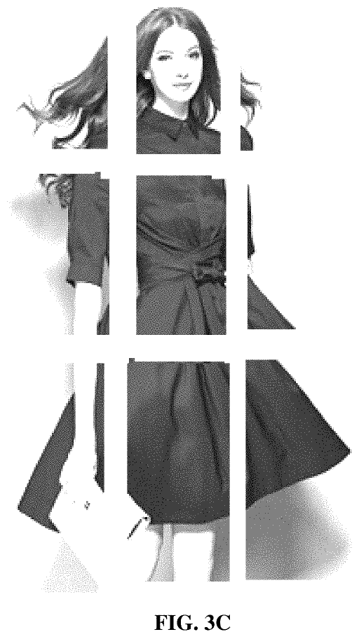

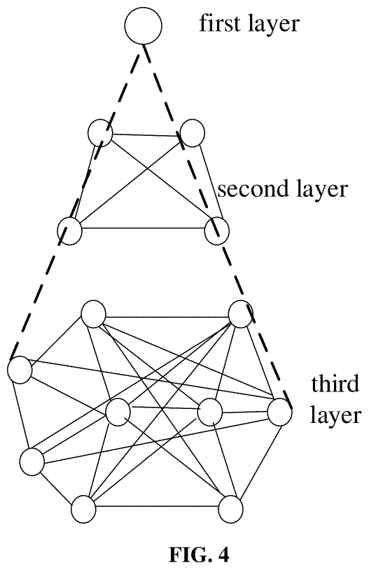

In this case, image pyramids corresponding respectively to the first image and the second image may be formed, as shown in FIG. 4, for example. The image of FIG. 2A may be taken as the level 1 of the image pyramid of the first image. The images of FIG. 2B may be taken as the level 2 of the image pyramid of the first image. The images of FIG. 2C may be taken as the level 3 of the image pyramid of the first image, so on and so forth, acquiring the image pyramid of the first image. The image pyramid of the second image may be acquired likewise. Each level of the image pyramid may correspond to a scale.

Then, the first feature map corresponding to the first image and the second feature map corresponding to the second image on each scale may be acquired corresponding respectively to the image pyramid of the first image and the image pyramid of the second image.

For example, for any scale in a set of scales {1, 2, . . . L}, feature extraction may be performed respectively on an image of a level i of the image pyramid of the first image and an image of a level j of the image pyramid of the second image using a Scale Invariant Feature Transform (SIFT) mode or a trained neural network, acquiring the first feature map corresponding to the first image on a scale i and the second feature map corresponding to the second image on a scale j. The i, as well as the j, may be any scale in the set of scales. Optionally, a googlenet network may be used as a trained neural network, which is not limited hereto.

For example, as shown in FIG. 5A, 4 first feature maps corresponding respectively to four spatial windows at the upper left corner, the bottom left corner, the upper right corner, and the bottom right corner may be extracted respectively for the first image on the scale 2 in the set of scales. For example, as shown in FIG. 5B, 9 second feature maps corresponding respectively to nine spatial windows may be extracted respectively for the second image on the scale 3 in the set of scales.

In S102, similarity between the first feature map and the second feature map located respectively at any two spatial locations is computed corresponding to a target scale combination of the preset multiple scales.

In an embodiment herein, the any two spatial locations may be identical or different. A target scale combination may include any first scale and any second scale in the preset multiple scales. A first scale and a second scale may be identical or different. The first feature map may correspond to the first scale. The second feature map may correspond to the second scale.

For example, assume that the first scale is the scale 2. Then, 4 first feature maps corresponding respectively to four spatial windows may be extracted respectively corresponding to the first image on the current scale. When the second scale is the scale 3, 9 second feature maps corresponding respectively to nine spatial windows may be extracted respectively corresponding to the second image.

In this case, similarity between the first feature map of the first image at any spatial location and the second feature map of the second image at any spatial location may have to be computed respectively corresponding to a target scale combination constituted by the scale 2 and the scale 3, acquiring 4×9=36 similarities in total.

Of course, if both the second scale and the first scale are the scale 2, 4×4=16 similarities may be acquired.

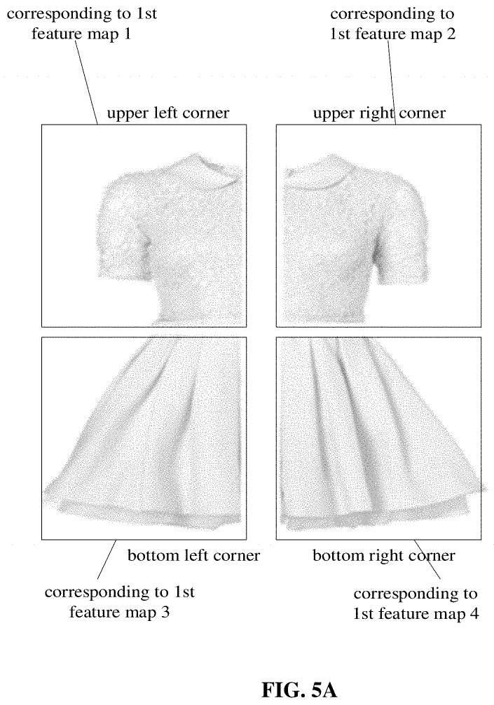

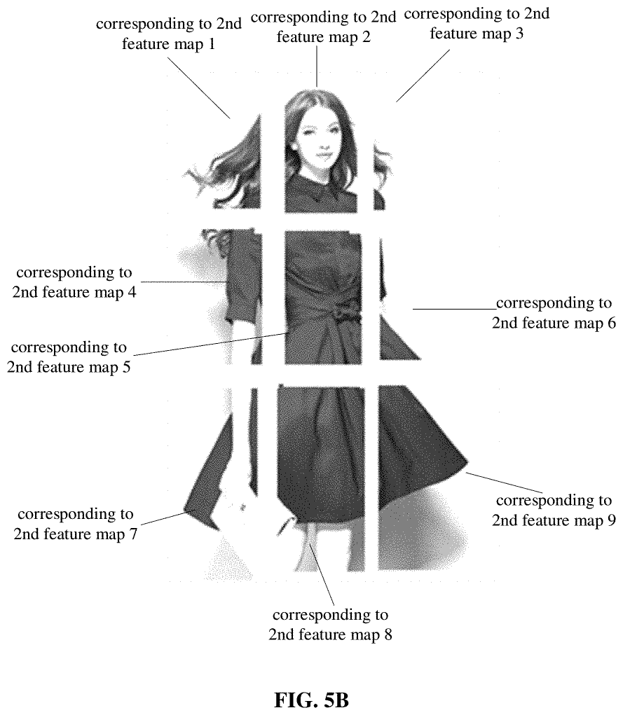

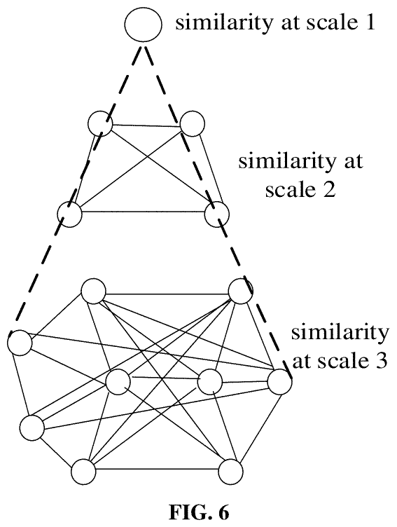

In an embodiment herein, the first scale and the second scale may be identical, for example. Then, a similarity pyramid may be acquired. As shown in FIG. 6, for example, both the first scale and the second scale may be the scale 1. Then, 1 similarity may be acquired, i.e., a global similarity. The similarity may be taken as the level 1 of the similarity pyramid. When both the first scale and the second scale are the scale 2, 16 local similarities may be acquired. The 16 similarities may be taken as the level 2 of the similarity pyramid. When both the first scale and the second scale are the scale 3, 81 local similarities may be acquired. The 81 similarities may be taken as the level 3 of the similarity pyramid, so on and so forth, thereby acquiring the similarity pyramid.

In S103, a target undirected graph is established according to similarities corresponding to respective target scale combinations.

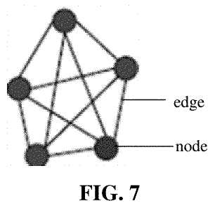

In an embodiment herein, as shown in FIG. 7, for example, each node of the target undirected graph may correspond to a similarity. Each similarity may correspond to a target scale combination. An edge of the target undirected graph may be represented by a weight between two nodes. The weight may be a normalized weight subjected to normalization processing. Similarity between two images may be represented more intuitively through the target undirected graph.

In S104, the target undirected graph is input to a target graph neural network that is pre-established. It is determined, according to an output result output by the target graph neural network, whether the second image is a target image that matches the first image.

In an embodiment herein, the target graph neural network may be a pre-established graph neural network including multiple graph convolutional layers and nonlinear activation function ReLU layers. An output result output by the graph neural network may be a probability of a similarity between nodes of an undirected graph.

In training a graph neural network, first, images on each scale in the preset multiple scales corresponding respective to any two labeled sample images in a sample image library may be acquired. Then, feature extraction may be performed respectively on the acquired images, acquiring multiple sample feature maps of the two sample images corresponding to respective scales. In addition, a similarity between two sample feature maps corresponding to each target scale combination may be computed. A sample undirected graph may be established according to similarities between sample feature maps corresponding to respective target scale combinations. The process is identical to S101 to S103, and is not repeated here.

As the two sample images may have labels or other information, it already may be determined whether the two sample images match each other. Assume that the two sample images match. The graph neural network may be trained by taking the sample undirected graph as an input to the graph neural network, and letting a probability of a similarity between nodes of the sample undirected graph output by the two matching sample images through the graph neural network be greater than a preset threshold, thereby acquiring the target graph neural network required by an embodiment herein.

In an embodiment herein, the target graph neural network may be pre-established. Then, the target undirected graph acquired in S103 may directly be input to the target graph neural network. It may be determined, according to a probability of a similarity between nodes of the target undirected graph output by the target graph neural network, whether the second image is the target image matching the first image.

Optionally, if the probability of the similarity between nodes of the target undirected graph is greater than a preset threshold, the second image may be the target image matching the first image. Otherwise, the second image is not the target image matching the first image.

In an embodiment herein, a target image in the image library matching the first image may be acquired by searching each second image in the image library according to the mode.

In the embodiment, multiple first feature maps corresponding to a first image and multiple second feature maps corresponding to a second image in an image library may be acquired by performing feature extraction respectively on the first image and the second image according to each scale of preset multiple scales. A similarity between a first feature map and a second feature map located at any two spatial locations may be computed corresponding to a target scale combination of the preset multiple scales. Accordingly, a target undirected graph may be established according to similarities corresponding to respective target scale combinations. The target undirected graph may be input to a target graph neural network that is pre-established. It may be determined whether the second image is a target image matching the first image. The process is no longer limited to global similarity analysis based on overall scales of two images. Instead, similarity analysis is performed combining preset multiple scales. It is determined whether two images match each other according to a local similarity between the first feature map of the first image corresponding to the first scale and the second feature map of the second image corresponding to the second scale located at any two spatial locations, improving a precision and robustness of the matching.

In some optional embodiments, the preset multiple scales may include a third scale and at least one fourth scale. The third scale may be a scale including all pixels in the first image. For example, the third scale may be the scale 1 in the set of scales, corresponding to the overall scale of the image.

A fourth scale may be less than the third scale. For example, a fourth scale may be the scale 2, corresponding to a case in which the first image or the second image is divided into 2×2 small-scale images, as shown in FIG. 8, for example.

With embodiments herein, in addition to the overall similarity between the first image and the second image, the similarity between images on different scales is also taken into account, thereby improving a precision and robustness of a matching result.

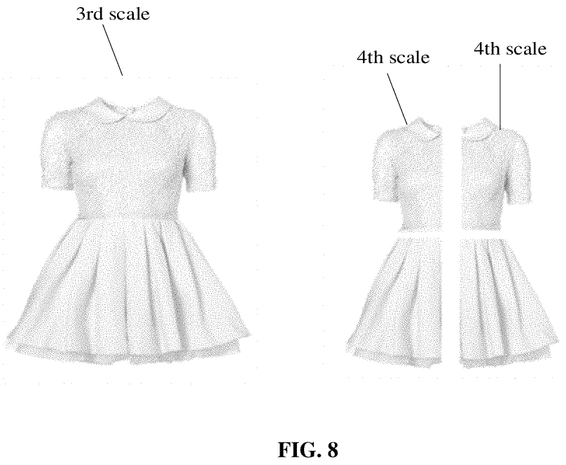

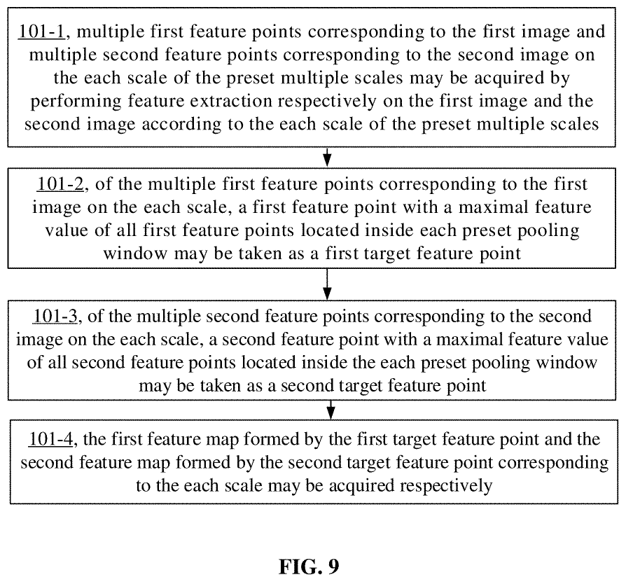

In some optional embodiments, as shown in FIG. 9, for example, S101 may include steps as follows.

In S101-1, multiple first feature points corresponding to the first image and multiple second feature points corresponding to the second image on the each scale of the preset multiple scales may be acquired by performing feature extraction respectively on the first image and the second image according to the each scale of the preset multiple scales.

In an embodiment herein, first, the image(s) corresponding to the first image and the image(s) corresponding to the second image may be acquired respectively according to each scale of preset multiple scales such as a set of scales {1, 2, . . . L}. For example, the first image may correspond to 4 images on the scale 2, and the second image may correspond to 4 images on the scale 2 as well.

Further, multiple first feature points corresponding to the first image and multiple second feature points corresponding to the second image on each scale may be acquired by performing feature extraction respectively on the image(s) corresponding to the first image and the image(s) corresponding to the second image on the each scale such as by way of SIFT or a trained neural network. For example, multiple first feature points corresponding to the first image on the scale 2 may be acquired by performing feature extraction respectively on the 4 images corresponding to the first image on the scale 2.

Optionally, a googlenet network may be used as a trained neural network, which is not limited hereto.

In S101-2, of the multiple first feature points corresponding to the first image on the each scale, a first feature point with a maximal feature value of all first feature points located inside each preset pooling window may be taken as a first target feature point.

A preset pooling window may be a given pooling window including multiple feature points. In an embodiment herein, feature dimension lowering may be performed in each preset pooling window respectively on all feature points included in the each preset pooling window. For example, by way of max-pooling, a feature point with a maximal feature value in all feature points included in each preset pooling window may be selected as a target feature point corresponding to the each preset pooling window. Any other feature point in the each preset pooling window may be discarded.

For example, a preset pooling window any include 4 feature points. Then, among multiple first feature points corresponding to the first image on each scale, as shown in FIG. 10A, a first feature point with a maximal feature value in all first feature points in each preset pooling window may be taken as a first target feature point. For example, in FIG. 10A, the first feature point 3 may be taken as the first target feature point in the first preset pooling window. The first feature point 5 may be taken as the first target feature point in the second preset pooling window.

In S101-3, of the multiple second feature points corresponding to the second image on the each scale, a second feature point with a maximal feature value of all second feature points located inside the each preset pooling window may be taken as a second target feature point.

A second target feature point may be determined for the second image on each scale in a mode same as in S101-2.

In S101-2 and S101-3, max-pooling may be performed respectively on multiple first feature points corresponding to the first image and multiple second feature points corresponding to the second image on each scale. With embodiments herein, in addition to max-pooling, processing such as average pooling may further be performed respectively on multiple first feature points corresponding to the first image and multiple second feature points corresponding to the second image on each scale. In average pooling, feature values of all feature points in each preset pooling window may be averaged. The average may be taken as the feature value corresponding to an image area in the each preset pooling window,

For example, as shown in FIG. 10B, a preset pooling window may include 4 first feature points with feature values 7, 8, 2, and 7, respectively, with an average 6. In average pooling, the feature value corresponding to the image area in the preset pooling window may be determined as the average 6.

In S101-4, the first feature map formed by the first target feature point and the second feature map formed by the second target feature point corresponding to the each scale may be acquired respectively.

All first target feature points determined corresponding to each scale may form the first feature map corresponding to the each scale. All second target feature points determined corresponding to each scale may constitute the second feature map corresponding to the each scale.

In some optional embodiments, corresponding to S102, the similarity Sₚ(xₗ_{₁}ⁱ,yₗ_{₂}^{j}) corresponding to a target scale combination may be acquired using a formula 1 as follows.

$${S}_{p} ( {x}_{{l}_{i}}^{i} , {y}_{{l}_{2}}^{j} ) = \frac{P {\vert {x}_{{l}_{i}}^{i} , {y}_{{l}_{2}}^{j} \vert}^{2}}{{‖ P {\vert {x}_{{l}_{i}}^{i} , {y}_{{l}_{2}}^{j} \vert}^{2} ‖}_{2}} \qquad formula 1$$

The xₗ_{₁}ⁱ may be the feature value of the first image at the ith spatial location on the first scale l₁. The yₗ_{₂}ⁱ may be the feature value of the second image at the jth spatial location on the second scale l₂. The P∈R^{D×C} may be a preset projection matrix that may lower a dimension of a feature difference vector from a dimension C to a dimension D. The R may represent a set of real numbers. The R^{D×C} may represent a D×C matrix formed by real numbers. The ∥*∥₂ may be an L2 norm, i.e., an Euclidean norm, of *. The i and the j may represent indices of pooling windows, respectively. For example, if the first scale is 3×3, the i may be any natural number in [1, 9]. If the second scale is 2×2, the j may be any natural number in [1, 4].

In an embodiment herein, regardless of whether the first scale and the second scale are identical or different, the formula 1 may be used to acquire the similarity corresponding to a target scale combination. The target scale combination may include the first scale and the second scale.

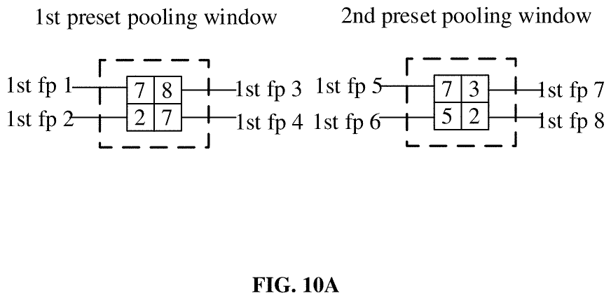

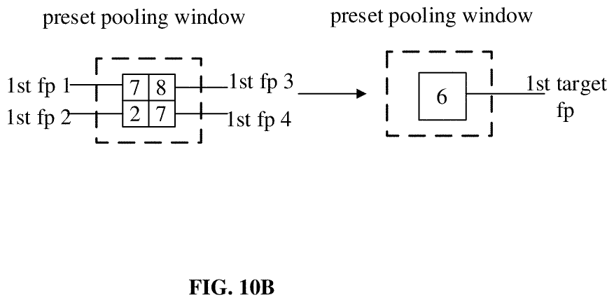

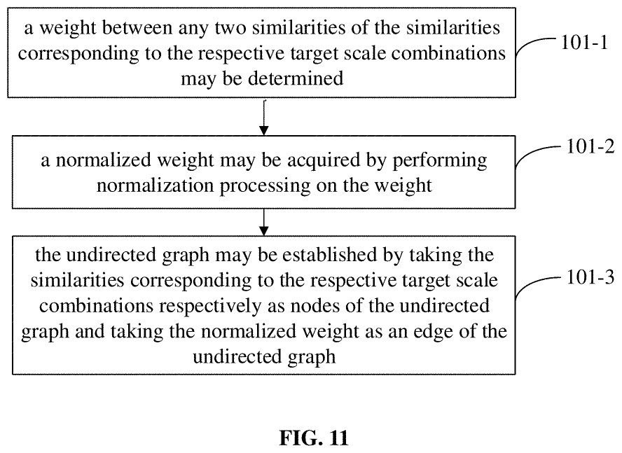

In some optional embodiments, for example, as shown in FIG. 11, the S103 may include steps as follows.

In S103-1, a weight between any two similarities of the similarities corresponding to the respective target scale combinations may be determined.

In an embodiment herein, a weight ωₚ^{l}^{₁}^{ij,l}^{₂}^{mn} between any two similarities may be computed directly using a formula 2 as follows.

$${ω}_{p}^{{l}_{1} ij , {l}_{2} mn} = \frac{exp ( {( {T}_{out} {S}_{{l}_{1}}^{ij} )}^{T} ( {T}_{in} {S}_{{l}_{2}}^{mn} ) )}{{\sum }_{l , p , q} exp ( {( {T}_{out} {S}_{{l}_{1}}^{ij} )}^{T} ( {T}_{in} {S}_{l}^{pq} ) )} \qquad formula 2$$

The

$${S}_{{l}_{1}}^{ij} = {\sum }_{{l}_{2} , m , n} {ω}_{p}^{{l}_{1} ij , {l}_{2} mn} {S}_{{l}_{2}}^{mn} = {\sum }_{{l}_{2} , m , n} {ω}_{p}^{{l}_{1} ij , {l}_{2} mn} {S}_{p} ( {x}_{{l}_{2}}^{m} , {y}_{{l}_{2}}^{n} ) .$$

The Tₒᵤₜ∈R^{D×D} may correspond to the linear conversion matrix of an output edge of each node. The Tᵢₙ∈R^{D×D} may correspond to the linear conversion matrix of an input edge of each node. The R may represent a set of real numbers. The R^{D×D} may represent a D×D matrix formed by real numbers. Optionally, scales l₁ and l₂ may be identical or different.

In an embodiment herein, if a node in the target undirected graph is a similarity between the first feature map and the second feature map on one scale l, the weight of the node may be computed using a formula 3.

$${ω}_{l}^{ij} = \{ \begin{matrix}1 , & j = arg max {x}_{k} ( {S}_{l} ( {x}^{i} , {y}^{k} ) ) \\ 0 , & otherwise\end{matrix} \qquad formula 3$$

The argmax may be an operation of taking the maximum.

If a node in the target undirected graph is a similarity between the first feature map corresponding to the scale l₁ and the second feature map corresponding to the scale l₂, and the l₁ differs from the l₂, the formula 3 may be transformed adaptively. Any mode of computing a weight by transformation based on the formula 3 falls within the scope of the subject disclosure.

In S103-2, a normalized weight may be acquired by performing normalization processing on the weight.

A normalized value of a weight ωₚ^{l}^{₁}^{ij,l}^{₂}^{mn} between two similarities Sₗ_{₁}^{ij} and Sₗ_{₂}^{mn} may be computed using a normalization function such as a softmax function.

In S103-3, the undirected graph may be established by taking the similarities corresponding to the respective target scale combinations respectively as nodes of the undirected graph and taking the normalized weight as an edge of the undirected graph.

For example, Sₗ_{₁}^{ij} and Sₗ_{₂}^{mn} may be taken as two nodes of the target undirected graph. Then, an edge between the two nodes may be a normalized weight between Sₗ_{₁}^{ij} and Sₗ_{₂}^{mn}, thereby acquiring the target undirected graph.

In some optional embodiments, corresponding to the S104, the target undirected graph established in S103 may be input to a pre-established target graph neural network.

In an embodiment herein, in establishing the target graph neural network, a graph neural network including multiple graph convolutional layers and nonlinear activation function ReLU layers may be established first. A sample undirected graph may be established using any two labeled sample images in a sample image library in a mode same as in the S101 to the S103, which is not repeated here.

As the two sample images may have labels or other information, it already may be determined whether the two sample images match each other. Assume that the two sample images match. The graph neural network may be trained by taking the sample undirected graph as an input to the graph neural network, and letting a probability of a similarity between nodes of the sample undirected graph output by the two matching sample images through the graph neural network be greater than a preset threshold, thereby acquiring the target graph neural network required by an embodiment herein.

In a target graph neural network, a probability of a similarity may be output through a normalization function such as a softmax function.

In an embodiment herein, a target undirected graph may be input to a target graph neural network, a different target undirected graph may be acquired each time a scale is added to a set of scales. For example, when the set of scales includes only the scale 1 and the scale 2, a target undirected graph 1 may be acquired. If the set of scales includes the scale 1, the scale 2, and the scale 3, a target undirected graph 2 may be acquired. The target undirected graph 1 may differ from the target undirected graph 2. The target graph neural network may update the target undirected graph anytime according to the number of scales in the set of scales.

Further, the S104 may include a step as follows.

When the probability of the similarity is greater than a preset threshold, it may be determined that the second image is a target image matching the first image.

An input target undirected graph may be analyzed using a target graph neural network. According to an output probability of the similarity between nodes of the target undirected graph, a second image corresponding to a similarity with a probability greater than a preset threshold may be taken as the target image matching the first image.

By searching all images in the image library in the mode, the target image matching the first image may be acquired.

In the embodiment, a similarity between images may be measured combining local features of the first image and the second image on different scales, improving a precision and robustness of the matching.

In some optional embodiments, such as when browsing an App, a user may find that the App recommends a new dress of the season. The user may want to purchase, on another shopping website, a dress similar to the new dress. In this case, the image of the new dress provided by the App may be taken as the first image, and images of all dresses provided by the shopping website may be taken as the second images.

With the method of the S101 to the S104 of an embodiment herein, the image of a dress similar to the new dress, that the user may want to purchase, may be found by directly searching the shopping website. Accordingly, the user may place an order to carry out the purchase.

As another example, a user may like a home appliance in an offline physical store. The user may want to search a website for a similar product. In this case, the user may take a picture of the home appliance in the physical store using user equipment such as a cell phone, take the acquired image as the first image, go to the website to be searched, and take all images in the website as the second images.

Likewise, with the method of the S101 to the S104 of an embodiment herein, images and prices of similar home appliances may be found by directly searching the website. The user may select to purchase a home appliance of a competitive price.

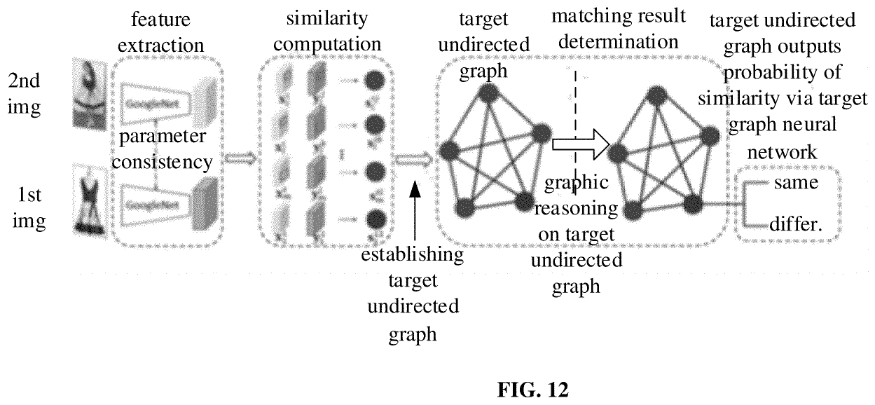

In some optional embodiments, for example, FIG. 12 is a diagram of a structure of an image search network provided herein.

The image search network may include a feature extraction part, a similarity computation part, and a matching result determination part.

Feature extraction may be performed on a first image and second images in an image library through the feature extraction part, acquiring a first feature map corresponding to the first image and a second feature map corresponding to the second image on multiple scales. Optionally, a googlenet network may be used as the feature extraction part. The first image and the second image may share one feature extractor, or two feature extractors may share one set of parameters.

Further, with the similarity computation part, a similarity between the first feature map and the second feature map located at one spatial location on one scale may be computed using the formula 1, thereby acquiring multiple similarities.

Further, with the matching result determination part, first, a target undirected graph may be established according to multiple similarities. Then, the target undirected graph may be input to a pre-established target graph neural network. Graphic reasoning may be performed according to the target graph neural network. Finally, it may be determined, according to a probability of a similarity between nodes of the output target undirected graph, whether a second image is a target image matching the first image.

In the embodiment, a similarity between images may be measured combining local features of the first image and the second image on different scales, improving a precision and robustness of the matching.

Corresponding to a method embodiment herein, embodiments herein further provides a device.

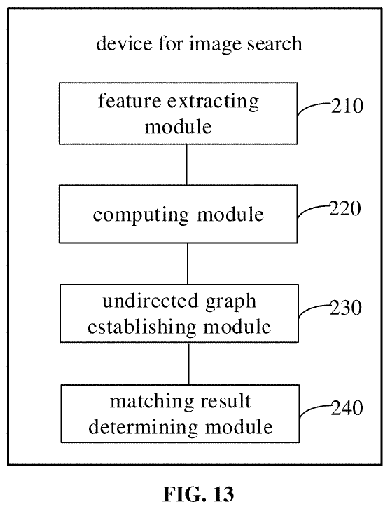

FIG. 13 is a block diagram of a device for image search according to an exemplary embodiment herein. As shown in FIG. 13, the device includes a feature extracting module, a computing module, an undirected graph establishing module, and a matching result determining module. The feature extracting module 210 is adapted to acquiring a first feature map corresponding to a first image and a second feature map corresponding to a second image by performing feature extraction respectively on the first image and the second image according to each scale of preset multiple scales. The second image is any image in an image library. The computing module 220 is adapted to computing, corresponding to a target scale combination of the preset multiple scales, similarity between the first feature map and the second feature map located at any two spatial locations. The target scale combination includes a first scale corresponding to the first feature map and a second scale corresponding to the second feature map. The first scale and the second scale each are any scale of the preset multiple scales. The undirected graph establishing module 230 is adapted to establishing a target undirected graph according to similarities corresponding to respective target scale combinations. The matching result determining module 240 is adapted to inputting the target undirected graph to a target graph neural network that is pre-established, and determining, according to an output result output by the target graph neural network, whether the second image is a target image matching the first image.

The embodiment is no longer limited to global similarity analysis based on overall scales of two images. Instead, similarity analysis is performed combining preset multiple scales. It is determined whether two images match each other according to a local similarity between the first feature map of the first image corresponding to the first scale and the second feature map of the second image corresponding to the second scale located at any two spatial locations, improving a precision and robustness of the matching.

In some optional embodiments, the preset multiple scales may include a third scale and at least one fourth scale. The third scale may be a scale including all pixels in the first image. Such a fourth scale may be less than the third scale.

In the embodiments, the preset multiple scales may include the third scale and at least one fourth scale. The third scale may be the overall scale of the first image. The at least one fourth scale may be less than the third scale. Accordingly, when computing the similarity between the first image and the second image, in addition to the overall similarity between the first image and the second image, the similarity between images on different scales is also taken into account, thereby improving a precision and robustness of a matching result.

In some optional embodiments, the feature extracting module 210 may include a feature extracting sub-module, a first determining sub-module, a second determining sub-module, and an acquiring sub-module. The feature extracting sub-module may be adapted to acquiring multiple first feature points corresponding to the first image and multiple second feature points corresponding to the second image on the each scale of the preset multiple scales by performing feature extraction respectively on the first image and the second image according to the each scale of the preset multiple scales. The first determining sub-module may be adapted to, of the multiple first feature points corresponding to the first image on the each scale, taking, as a first target feature point, a first feature point with a maximal feature value of all first feature points located inside each preset pooling window. The second determining sub-module may be adapted to, of the multiple second feature points corresponding to the second image on the each scale, taking, as a second target feature point, a second feature point with a maximal feature value of all second feature points located inside the each preset pooling window. The acquiring sub-module may be adapted to respectively acquiring the first feature map formed by the first target feature point and the second feature map formed by the second target feature point corresponding to the each scale.

In the embodiments, multiple first feature points of the first image and multiple second feature points of the second image on each scale may be processed by way of max-pooling, focusing on information about important elements in the first image and the second image, increasing accuracy in subsequent computation of a similarity between a first feature map and a second feature map, while reducing computation.

In some optional embodiments, the computing module 220 may include a first computing sub-module, a second computing sub-module, a third computing sub-module, and a fourth computing sub-module. The first computing sub-module may be adapted to computing a sum of squares of a difference between a feature value of the first feature map corresponding to the first scale at an ith spatial location and a feature value of the second feature map corresponding to the second scale at a jth spatial location. The second computing sub-module may be adapted to computing a product of the sum of squares and a preset projection matrix. The preset projection matrix may be adapted to lowering a dimension of a feature difference vector. The third computing sub-module may be adapted to computing an Euclidean norm of the product. The fourth computing sub-module may be adapted to taking a quotient acquired by dividing the product by the Euclidean norm as the similarity corresponding to the target scale combination.

In the embodiments, the similarity between the first feature map corresponding to the first scale and the second feature map corresponding to the second scale at any two spatial locations may be computed. The first scale and the second scale may be identical or different, which is highly usable.

In some optional embodiments, the undirected graph establishing module 230 may include a third determining sub-module, a normalization processing sub-module, and an undirected graph establishing sub-module. The third determining sub-module may be adapted to determining a weight between any two similarities of the similarities corresponding to the respective target scale combinations. The normalization processing sub-module may be adapted to acquiring a normalized weight by performing normalization processing on the weight. The undirected graph establishing sub-module may be adapted to establishing the target undirected graph by taking the similarities corresponding to the respective target scale combinations respectively as nodes of the target undirected graph and taking the normalized weight as an edge of the target undirected graph.

In the embodiments, in establishing the target undirected graph, the similarities corresponding to the respective target scale combinations may be taken as nodes of the target undirected graph, the weight between any two nodes may be normalized, and the normalized weight may be taken as an edge of the target undirected graph. Similarities between two images on multiple scales are merged through the target undirected graph, thereby increasing a precision and robustness of a matching result.

In some optional embodiments, the output result of the target graph neural network may include a probability of similarity between nodes of the target undirected graph. The matching result determining module 240 may include a fourth determining sub-module. The fourth determining sub-module may be adapted to, in response to the probability of the similarity being greater than a preset threshold, determining that the second image is the target image matching the first image.

In the embodiments, the target undirected graph may be input to the target graph neural network. It may be determined whether the second image is the target image matching the first image according to whether a probability of a similarity between nodes of the target undirected graph output by the target graph neural network is greater than a preset threshold. When the probability of the similarity between nodes is large, the second image may be taken as the target image matching the first image. In this way, the target image in the image library that matches the first image may be found more accurately, with a more accurate searching result.

An apparatus embodiment herein basically corresponds to a method embodiment herein, description of which may be referred to for a related part thereof. An apparatus embodiment described herein is but schematic. Units described herein as separate parts may or may not be physically separate. A part displayed as a unit may or may not be a physical unit. That is, it may be located in one place, or distributed over multiple network units. Some or all of the modules herein may be selected as needed to achieve an effect of a solution herein. A person having ordinary skill in the art may understand and implement the above without creative effort.

Embodiments herein further provide a computer-readable storage medium having stored thereon computer-executable instructions for implementing a method for image search herein.

Embodiments herein further provide a device for image search. The device includes a processor and memory adapted to storing instructions executable by the processor. The processor is adapted to implementing, by calling the executable instructions stored in the memory, any method for image search herein.

Embodiments herein further provide a computer program product including a computer-readable code which, when executed on equipment, allows a processor in the equipment to implement any method for image search herein.

Embodiments herein further provide a computer program product having stored thereon computer-readable instructions which, when executed, allow a computer to implement any method for image search herein.

The computer program product may be implemented by hardware, software, or a combination thereof. In an optional embodiment, the computer program product may be a computer storage medium. In another optional embodiment, the computer program product may be a software product, such as a Software Development Kit, SDK, etc.

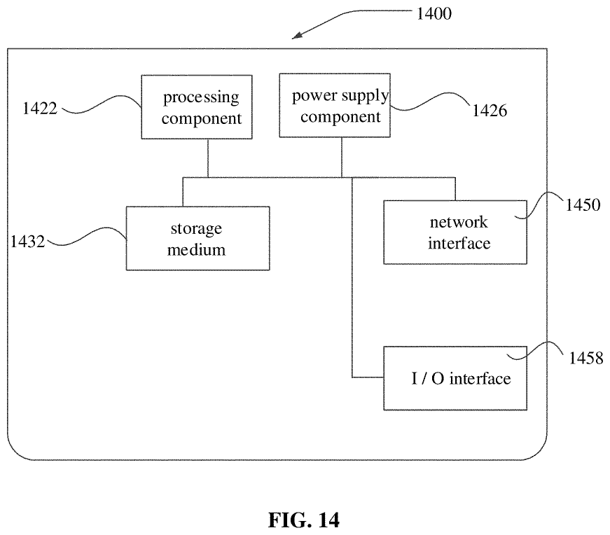

FIG. 14 is a diagram of a structure of a device 1400 for image search according to some embodiments. In some optional embodiments, as shown in FIG. 14, the device 1400 may include a processing component 1422. The processing component may include one or more processors. The device may include a memory resource represented by memory 1432. The memory may be adapted to storing instructions executable by the processing component 1422, such as an APP. The APP stored in the memory 1432 may include one or more modules. Each of the modules may correspond to a group of instructions. In addition, the processing component 1422 may be adapted to executing instructions to perform the method for image search herein.

The device 1400 may further include a power supply component 1426. The power supply component may be adapted to managing power of the device 1400. The device may further include a wired or wireless network interface 1450 adapted to connecting the device 1400 to a network. The device may further include an Input/Output (I/O) interface 1458. The device 1400 may operate based on an operating system stored in the memory 1432, such as a Windows Server™, a Mac OS X™, a Unix™, a Linux™, a FreeB SD™, etc.

Embodiments herein further provide a computer program including a computer-readable code which, when executed in electronic equipment, allows a processor in the electronic equipment to implement a method herein.

Other implementations of the subject disclosure will be apparent to a person having ordinary skill in the art that has considered the specification and or practiced the subject disclosure. The subject disclosure is intended to cover any variation, use, or adaptation of the subject disclosure following the general principles of the subject disclosure and including such departures from the subject disclosure as come within common knowledge or customary practice in the art. The specification and the embodiments are intended to be exemplary only, with a true scope and spirit of the subject disclosure being indicated by the appended claims.

What described are merely embodiments herein, and are not intended to limit the subject disclosure. Any modification, equivalent replacement, improvement, and/or the like made within the spirit and principle herein should be included in the scope of the subject disclosure.

What is claimed is:

1. A method for image search, comprising:
acquiring a first feature map corresponding to a first image and a second feature map corresponding to a second image by performing feature extraction respectively on the first image and the second image according to each scale of preset multiple scales, wherein the second image is any image in an image library;
computing, corresponding to a target scale combination of the preset multiple scales, similarity between the first feature map and the second feature map located at any two spatial locations, wherein the target scale combination comprises a first scale corresponding to the first feature map and a second scale corresponding to the second feature map, the first scale and the second scale each being any scale of the preset multiple scales;
establishing an undirected graph according to similarities corresponding to respective target scale combinations; and
inputting the undirected graph to a graph neural network that is pre-established, and determining, according to an output result output by the graph neural network, whether the second image matches the first image.

2. The method of claim 1, wherein one of the preset multiple scales is a scale comprising all pixels in the first image.

3. The method of claim 1, wherein acquiring the first feature map corresponding to the first image and the second feature map corresponding to the second image by performing feature extraction respectively on the first image and the second image according to the each scale of the preset multiple scales comprises:
acquiring multiple first feature points corresponding to the first image and multiple second feature points corresponding to the second image on the each scale of the preset multiple scales by performing feature extraction respectively on the first image and the second image according to the each scale of the preset multiple scales;
of the multiple first feature points corresponding to the first image on the each scale, taking, as a first target feature point, a first feature point with a maximal feature value of all first feature points located inside each preset pooling window;
of the multiple second feature points corresponding to the second image on the each scale, taking, as a second target feature point, a second feature point with a maximal feature value of all second feature points located inside the each preset pooling window; and
respectively acquiring the first feature map formed by the first target feature point and the second feature map formed by the second target feature point corresponding to the each scale.

4. The method of claim 1, wherein computing, corresponding to the target scale combination of the preset multiple scales, the similarity between the first feature map and the second feature map located at the any two spatial locations, comprises:
computing a sum of squares of a difference between a feature value of the first feature map corresponding to the first scale at a first spatial location and a feature value of the second feature map corresponding to the second scale at a second spatial location, wherein the first spatial location represents a location of any pooling window of the first feature map, wherein the second spatial location represents a location of any pooling window of the second feature map;
computing a product of the sum of squares and a preset projection matrix, wherein the preset projection matrix is adapted to lowering a dimension of a feature difference vector;
computing an Euclidean norm of the product; and
taking a quotient acquired by dividing the product by the Euclidean norm as the similarity corresponding to the target scale combination.

5. The method of claim 1, wherein establishing the undirected graph according to the similarities corresponding to the respective target scale combinations comprises:
determining a weight between any two similarities of the similarities corresponding to the respective target scale combinations;
acquiring a normalized weight by performing normalization processing on the weight; and
establishing the undirected graph by taking the similarities corresponding to the respective target scale combinations respectively as nodes of the undirected graph and taking the normalized weight as an edge of the undirected graph.

6. The method of claim 1, wherein the output result of the graph neural network comprises a probability of similarity between nodes of the undirected graph,
wherein determining, according to the output result output by the graph neural network, whether the second image matches the first image comprises:
in response to the probability of the similarity being greater than a preset threshold, determining that the second image matches the first image.

7. The method of claim 2, wherein acquiring the first feature map corresponding to the first image and the second feature map corresponding to the second image by performing feature extraction respectively on the first image and the second image according to the each scale of the preset multiple scales comprises:
acquiring multiple first feature points corresponding to the first image and multiple second feature points corresponding to the second image on the each scale of the preset multiple scales by performing feature extraction respectively on the first image and the second image according to the each scale of the preset multiple scales;
of the multiple first feature points corresponding to the first image on the each scale, taking, as a first target feature point, a first feature point with a maximal feature value of all first feature points located inside each preset pooling window;
of the multiple second feature points corresponding to the second image on the each scale, taking, as a second target feature point, a second feature point with a maximal feature value of all second feature points located inside the each preset pooling window; and
respectively acquiring the first feature map formed by the first target feature point and the second feature map formed by the second target feature point corresponding to the each scale.

8. A device for image search, comprising a processor and memory,
wherein the memory is adapted to storing instructions executable by the processor,
wherein the processor is configured to implement:
acquiring a first feature map corresponding to a first image and a second feature map corresponding to a second image by performing feature extraction respectively on the first image and the second image according to each scale of preset multiple scales, wherein the second image is any image in an image library;
computing, corresponding to a target scale combination of the preset multiple scales, similarity between the first feature map and the second feature map located at any two spatial locations, wherein the target scale combination comprises a first scale corresponding to the first feature map and a second scale corresponding to the second feature map, the first scale and the second scale each being any scale of the preset multiple scales;
establishing an undirected graph according to similarities corresponding to respective target scale combinations; and
inputting the undirected graph to a graph neural network that is pre-established, and determining, according to an output result output by the graph neural network, whether the second image matches the first image.

9. The device of claim 8, wherein one of the preset multiple scales is a scale comprising all pixels in the first image.

10. The device of claim 8, wherein the processor is configured to acquire the first feature map corresponding to the first image and the second feature map corresponding to the second image by performing feature extraction respectively on the first image and the second image according to the each scale of the preset multiple scales, by:
acquiring multiple first feature points corresponding to the first image and multiple second feature points corresponding to the second image on the each scale of the preset multiple scales by performing feature extraction respectively on the first image and the second image according to the each scale of the preset multiple scales;
of the multiple first feature points corresponding to the first image on the each scale, taking, as a first target feature point, a first feature point with a maximal feature value of all first feature points located inside each preset pooling window;
of the multiple second feature points corresponding to the second image on the each scale, taking, as a second target feature point, a second feature point with a maximal feature value of all second feature points located inside the each preset pooling window; and
respectively acquiring the first feature map formed by the first target feature point and the second feature map formed by the second target feature point corresponding to the each scale.

11. The device of claim 8, wherein the processor is configured to compute, corresponding to the target scale combination of the preset multiple scales, the similarity between the first feature map and the second feature map located at the any two spatial locations, by:
computing a sum of squares of a difference between a feature value of the first feature map corresponding to the first scale at a first spatial location and a feature value of the second feature map corresponding to the second scale at a second spatial location, wherein the first spatial location represents a location of any pooling window of the first feature map, wherein the second spatial location represents a location of any pooling window of the second feature map;
computing a product of the sum of squares and a preset projection matrix, wherein the preset projection matrix is adapted to lowering a dimension of a feature difference vector;
computing an Euclidean norm of the product; and
taking a quotient acquired by dividing the product by the Euclidean norm as the similarity corresponding to the target scale combination.

12. The device of claim 8, wherein the processor is configured to establish the undirected graph according to the similarities corresponding to the respective target scale combinations, by:
determining a weight between any two similarities of the similarities corresponding to the respective target scale combinations;
acquiring a normalized weight by performing normalization processing on the weight; and
establishing the undirected graph by taking the similarities corresponding to the respective target scale combinations respectively as nodes of the undirected graph and taking the normalized weight as an edge of the undirected graph.

13. The device of claim 8, wherein the output result of the graph neural network comprises a probability of similarity between nodes of the undirected graph,
wherein the processor is configured to determine, according to the output result output by the graph neural network, whether the second image matches the first image, by:
in response to the probability of the similarity being greater than a preset threshold, determining that the second image matches the first image.

14. The device of claim 9, wherein the processor is configured to acquire the first feature map corresponding to the first image and the second feature map corresponding to the second image by performing feature extraction respectively on the first image and the second image according to the each scale of the preset multiple scales, by:
acquiring multiple first feature points corresponding to the first image and multiple second feature points corresponding to the second image on the each scale of the preset multiple scales by performing feature extraction respectively on the first image and the second image according to the each scale of the preset multiple scales;
of the multiple first feature points corresponding to the first image on the each scale, taking, as a first target feature point, a first feature point with a maximal feature value of all first feature points located inside each preset pooling window;
of the multiple second feature points corresponding to the second image on the each scale, taking, as a second target feature point, a second feature point with a maximal feature value of all second feature points located inside the each preset pooling window; and
respectively acquiring the first feature map formed by the first target feature point and the second feature map formed by the second target feature point corresponding to the each scale.

15. A non-transitory computer-readable storage medium, having stored thereon computer-executable instructions which, when executed by a processor, implement:
acquiring a first feature map corresponding to a first image and a second feature map corresponding to a second image by performing feature extraction respectively on the first image and the second image according to each scale of preset multiple scales, wherein the second image is any image in an image library;
computing, corresponding to a target scale combination of the preset multiple scales, similarity between the first feature map and the second feature map located at any two spatial locations, wherein the target scale combination comprises a first scale corresponding to the first feature map and a second scale corresponding to the second feature map, the first scale and the second scale each being any scale of the preset multiple scales;
establishing an undirected graph according to similarities corresponding to respective target scale combinations; and
inputting the undirected graph to a graph neural network that is pre-established, and determining, according to an output result output by the graph neural network, whether the second image matches the first image.

16. The non-transitory computer-readable storage medium of claim 15, wherein one of the preset multiple scales is a scale comprising all pixels in the first image.

17. The non-transitory computer-readable storage medium of claim 15, wherein acquiring the first feature map corresponding to the first image and the second feature map corresponding to the second image by performing feature extraction respectively on the first image and the second image according to the each scale of the preset multiple scales comprises:
acquiring multiple first feature points corresponding to the first image and multiple second feature points corresponding to the second image on the each scale of the preset multiple scales by performing feature extraction respectively on the first image and the second image according to the each scale of the preset multiple scales;
of the multiple first feature points corresponding to the first image on the each scale, taking, as a first target feature point, a first feature point with a maximal feature value of all first feature points located inside each preset pooling window;
of the multiple second feature points corresponding to the second image on the each scale, taking, as a second target feature point, a second feature point with a maximal feature value of all second feature points located inside the each preset pooling window; and
respectively acquiring the first feature map formed by the first target feature point and the second feature map formed by the second target feature point corresponding to the each scale.

18. The non-transitory computer-readable storage medium of claim 15, wherein computing, corresponding to the target scale combination of the preset multiple scales, the similarity between the first feature map and the second feature map located at the any two spatial locations, comprises:
computing a sum of squares of a difference between a feature value of the first feature map corresponding to the first scale at a first spatial location and a feature value of the second feature map corresponding to the second scale at a second spatial location, wherein the first spatial location represents a location of any pooling window of the first feature map, wherein the second spatial location represents a location of any pooling window of the second feature map;
computing a product of the sum of squares and a preset projection matrix, wherein the preset projection matrix is adapted to lowering a dimension of a feature difference vector;
computing an Euclidean norm of the product; and
taking a quotient acquired by dividing the product by the Euclidean norm as the similarity corresponding to the target scale combination.

19. The non-transitory computer-readable storage medium of claim 15, wherein establishing the undirected graph according to the similarities corresponding to the respective target scale combinations comprises:
determining a weight between any two similarities of the similarities corresponding to the respective target scale combinations;
acquiring a normalized weight by performing normalization processing on the weight; and
establishing the undirected graph by taking the similarities corresponding to the respective target scale combinations respectively as nodes of the undirected graph and taking the normalized weight as an edge of the undirected graph.

20. The non-transitory computer-readable storage medium of claim 15, wherein the output result of the graph neural network comprises a probability of similarity between nodes of the undirected graph,
wherein determining, according to the output result output by the graph neural network, whether the second image matches the first image comprises:
in response to the probability of the similarity being greater than a preset threshold, determining that the second image matches the first image.
